(19) United States
(12) Patent Application Publication
(10) Pub. No.: US 2026/0345437 A1
(43) Pub. Date: Nov. 5, 2026

(54) ADAPTIVE BIO-RESONANT HEALING CHAMBER SYSTEM AND METHOD

(71) Applicant: PinTech LLC, Aurora, CO (US)

(72) Inventor: Vincent Johnson, Denver, CO (US)

(73) Assignee: PinTech LLC, Aurora, CO (US)

(21) Appl. No.: 19/739,114

(22) Filed: Jul. 13, 2026

Related U.S. Application Data
(63) Continuation-in-part of application No. 18/053,366, filed on Nov. 7, 2022, now Pat. No. 12,702,619.
(60) Provisional application No. 63/276,174, filed on Nov. 5, 2021.

(51) Int. Cl. A61H 33/06

(52) U.S. Cl. CPC A61H 33/065; A61H 33/066; A61H 2201/10

(57) ABSTRACT

The disclosed technology includes devices, systems, and methods of fabricating and using a therapeutic tent to non-invasively treat burns, respiratory illnesses, muscle issues, and various other illnesses and physical, psychological, and emotional conditions. In some implementations, the disclosed system includes a hermetically sealed tent enclosure formed of Mylar, hemp, or a combination thereof; a steam source configured to supply steam to the enclosure; a multispectral light array configured to emit wavelengths between approximately 380 nm and 1100 nm; and a sound source configured to generate frequencies between approximately 1 Hz and 20 kHz, including Solfeggio frequencies. An adaptive controller utilizes machine-learning algorithms to correlate biofeedback signals with stored resonance profiles to deliver individualized therapy and/or synchronized group therapy. In certain implementations, multiple users may participate simultaneously through a secure cloud-connected neural network that promotes physiological synchronization, adaptive therapeutic optimization, neuroplasticity development, and community-based therapeutic coherence.

### CROSS-REFERENCE TO RELATED APPLICATIONS

This application is a continuation-in-part of U.S. patent application Ser. No. 18/053,366, filed Nov. 7, 2022, which claims the benefit of U.S. Provisional Patent Application No. 63/276,174, filed Nov. 5, 2021, the entire disclosures of which are hereby incorporated by reference.

### TECHNICAL FIELD

This disclosure relates to a steam tent device that can be used with a sound source and a light source to treat various burns, illnesses, diseases, and other medical conditions.

### BACKGROUND

Steam bathing is an old practice used by many cultures in different countries. With the growing number of fitness clubs, spas, and wellness centers, steam rooms are commonly used after workouts and in spas for relaxation and recovery. Unfortunately, accessibility to these facilities may be challenging for many people. People either do not have the funds to consistently take advantage of high-quality steam facilities or lack the time to take advantage of a high-quality facility. Even if a person has the time, money, and access to quality steam facilities, the likelihood of feeling comfortable in an environment that is not private can cause anxiety and be counterproductive.

Moreover, traditional sauna and light therapy systems lack intelligent synchronization of multisensory modalities. Existing systems do not adapt to a user's real-time physiological state, nor do they integrate steam, light, and sound in a coordinated, AI-driven manner. There remains a need for an advanced therapeutic environment combining light, sound, and steam within an enclosure capable of self-adjustment using biofeedback and machine-learning algorithms.

### SUMMARY

The disclosed technology is directed to a tent device. In some implementations, the present disclosure includes a tent system, including a tent, a steam source configured to supply an interior of the tent with steam, and a light source configured to illuminate the tent. The tent, the steam, and the light source are configured to treat a condition. The tent may be made of hemp. In some implementations, the tent is hermetically sealed. In some implementations, the tent is an anti-microbial environment.

In some implementations, the tent may be formed of Mylar or hemp, or a combination thereof. Mylar provides reflective properties for optimized light therapy efficacy, while hemp provides antimicrobial characteristics. In some implementations, when the Mylar layer is incorporated into a substantially continuous conductive enclosure with appropriate grounding or conductive continuity, the Mylar layer may attenuate certain external electromagnetic fields and radio-frequency (RF) energy, thereby helping maintain a controlled therapeutic environment. The combination of Mylar and hemp enables an enclosure having both reflective and antimicrobial performance.

In some implementations, the steam source includes a water tank, a water filler, a pressurized steam generator, a vaporizer, and an overflow tank. The steam source may provide steam in a range of 105-120 degrees Fahrenheit.

In some implementations, the light source is LED/infrared. In some implementations, the tent system further includes a sound source. In some implementations, the sound source is 432 Hz.

In some implementations, the sound source includes harmonic sound generators producing frequencies in a range of 1 Hz to 20 kHz, including Solfeggio frequencies at 174 Hz, 285 Hz, 396 Hz, 417 Hz, 528 Hz, 639 Hz, 741 Hz, 852 Hz, and 963 Hz. Speakers or transducers emit programmable tones across this full frequency range.

In other implementations, wireless technology may be used to control at least one of the steam source, the light source, and the sound source. The tent system may be portable, and in some cases weighs less than 50 lbs.

In some implementations, the light source includes a multispectral light array emitting wavelengths in a range of 380 nm to 1100 nm, covering the full visible and near-infrared spectrum. LED arrays may emit light in red, blue, green, and infrared ranges within this spectrum.

In some implementations, the present disclosure includes a method for fabricating a tent system, including providing a hermetically sealed tent, implementing a steam source into the hermetically sealed tent, affixing at least one light source into the hermetically sealed tent, and providing a sound source to the hermetically sealed tent. The tent may be made of a variety of materials (e.g., hemp). In some implementations, a method of using a tent system includes providing a hermetically sealed tent, providing a steam source, providing a light source, providing a sound source, and placing a user inside the hermetically sealed tent, and exposing the user to steam, light, and sound.

In some implementations, a method of treatment of a condition includes providing a hermetically sealed tent, the hermetically sealed tent including a steam source, a light source, and a sound source, determining a first predetermined administration of steam based on the condition, determining a second predetermined administration of light based on the condition, determining a third predetermined administration of sound based on the condition, placing a user inside the hermetically sealed tent, administering the first predetermined administration of the steam to the user, administering the second predetermined administration of the light to the user, and administering the third predetermined administration of the sound to the user.

In some implementations, the determined second predetermined administration of the light is selected from LED/infrared light. In some implementations, red light is selected if the condition includes at least one of muscle, immunological, metabolic, skin, and blood circulation conditions. In some implementations, blue light is selected if the condition includes at least one of skin and fluid conditions. In some implementations, green light is selected if the condition includes skin conditions. In some implementations, the third predetermined administration of the sound is at 432 Hz.

In some implementations, the tent system includes an adaptive controller using machine-learning algorithms to correlate biofeedback signals with stored resonance profiles to deliver individualized therapy. The controller automatically adjusts steam temperature, humidity, light intensity, and sound frequency based on user biofeedback. Biofeedback may include electrocardiogram data, electroencephalogram data, galvanic skin response data, and/or temperature data.

In some implementations, the controller generates predictive healing sequences combining steam, light, and sound cycles for detoxification, relaxation, and bio-energetic alignment. In some implementations, therapy data are securely stored and accessible to practitioners via encrypted cloud connectivity.

These and various other features and advantages will be apparent from a reading of the following detailed description.

### BRIEF DESCRIPTION OF THE DRAWINGS

Implementations are disclosed in association with the accompanying drawings in which:

FIG. 1 illustrates a schematic diagram of a tent system in accordance with aspects in the present disclosure.

FIG. 2 illustrates a schematic diagram of a steam source in accordance with aspects in the present disclosure.

FIG. 3 illustrates another schematic diagram of a steam source in accordance with aspects in the present disclosure.

FIGS. 4A and 4B illustrate schematic diagrams of a top view and a front view of a tent system in accordance with aspects in the present disclosure.

FIGS. 5A and 5B illustrate schematic diagrams of a rear view and an isometric view of a tent system in accordance with aspects in the present disclosure.

FIG. 6 is a perspective view of a steam source of a tent system in accordance with aspects in the present disclosure.

FIG. 7 illustrates a perspective view of a steam source of a tent system in accordance with aspects in the present disclosure.

FIG. 8A-C are schematic diagrams of a steam source of a tent system in accordance with aspects in the present disclosure.

FIG. 9A-C illustrate perspective views of a steam source of a tent system in accordance with aspects in the present disclosure.

FIG. 10 illustrates a schematic diagram of a steam source in accordance with aspects in the present disclosure.

FIG. 11 is a flowchart of an example Bluetooth control system for controlling a tent system in accordance with aspects in the present disclosure.

FIG. 12 is a perspective view of a contoured steam dispenser of a tent system in accordance with aspects in the present disclosure.

FIG. 13 is a flowchart of example operations for methods for fabricating a tent system in accordance with aspects in the present disclosure.

FIG. 14 is a flowchart of example operations for methods for using a tent system in accordance with aspects in the present disclosure.

FIG. 15 illustrates a schematic diagram of a system including a device that supports an adaptive controller for a therapeutic tent system in accordance with aspects in the present disclosure.

FIG. 16 is a flowchart of example operations of a method of using a tent system having an adaptive controller in accordance with aspects in the present disclosure.

### DETAILED DESCRIPTION

The present disclosure is directed to a therapeutic tent system that includes a tent and combinations of a steam source, a light source, and a sound source.

Conventional steam rooms are rooms at a spa or workout facility and require a user to travel for use. Furthermore, users need to pay for the steam room use. Further yet, while steam itself provides numerous health benefits, there are other components (e.g., light, sound) that can facilitate faster and better treatment and recovery and for more illnesses and conditions.

In accordance with aspects of the present disclosure, to address some of these shortcomings, a mobile, affordable, and convenient tent system is described that may effectively and efficiently treat various physical, psychological, and emotional conditions of a user. The tent system treats users suffering from various conditions, including, but not limited to, PTSD, muscle related injuries, inflammation, circulatory issues, muscle issues, and burn victims.

More specifically, by way of example, the tent system:
1. Improves circulation: Sitting in a steam room may significantly improve cardiovascular health. A study of older individuals showed that moist heat improved circulation, especially in extremities. Improved circulation can lead to lowered blood pressure and a healthier heart. It can also promote healing of broken skin tissue.
2. Lowers blood pressure: Research shows that in a steam room, some individual's bodies release hormones that change their heart rate. One of these hormones, called aldosterone, regulates blood pressure. When aldosterone is released from sitting in the steam room, it can help lower high blood pressure. This is part of the reason that the steam room makes most individuals feel relaxed.
3. Reduces stress: Being in the steam room can also decrease an individual's production of cortisol. Cortisol is the hormone that regulates the level of stress that an individual may feel. When cortisol levels drop, an individual feels more in control and relaxed. Spending a few minutes in a relaxed state not only improves your health, but also helps heal the mind and improves focus.
4. Clears congestion: Steam rooms create an environment that warms the mucous membrane and encourages deep breathing. As a result, using one can help break up congestion inside sinuses and lungs. Steam therapy used for treating colds and sinus infections at home is controversial because of the potential for scalding if used incorrectly. However, steam rooms are relatively safe in comparison, provided there is not overexposure. A study performed on a group of children found that children with respiratory infections recovered more quickly after steam therapy than children who did not use steam therapy.
5. Promotes skin health: Through environmental exposure, toxins can become trapped underneath the skin. Steam rooms help solve that problem by using heat to open up your pores. The warm condensation rinses away the dirt and dead skin that can lead to breakouts. As a result, an individual can have clearer and more even-toned skin from stream room use.
6. Aids in workout recovery: The pain an individual may feel after working out is called delayed onset muscles soreness (DOMS). Professional athletes have known for decades that heat therapy can help them recover from training workouts. Heat can penetrate deep into muscle tissue and help relieve DOMS. A recent study showed that moist heat works as effectively and more quickly than dry heat in muscle recovery.
7. Loosens stiff joints: Warming up before a workout is critical in avoiding injury. Using a steam room as part of a warm-up could help an individual reach maximum mobility during activities such as running, Pilates, and yoga. One study found that when heat was applied to the knee joint before activity, the joint was far more flexible and relaxed. The results showed that heat can help reduce injury before a workout. It was also found that women especially benefited from heat therapy on the knee joint to prevent injury.
8. Burns calories: A steam room or sauna increased heart rate. If you use a steam room after an aerobic workout, the heart rate is already elevated, and the steam room can prolong that elevation. When used correctly, experts note that saunas and steam rooms stimulate the body in ways that typical exercise does not. While weight loss in a steam room is likely water weight, which will need to be replaced by water to avoid dehydration, using steam rooms regularly as a way to burn more calories at the gym may help a diet and exercise routine be more effective.
9. Boosts the immune system: Different forms of hydrotherapy, including steam rooms, are known to boost immunity. Exposing the body to warm water stimulates leukocytes, cells that fight infection. Using steam rooms regularly may provide an immunity boost to the bloodstream that can result in reducing sickness.
10. Treats PTSD: Light therapy is used by some alternative medicine practitioners to treat wounds and pain. The light from the diodes has been shown to boost the output of nitric oxide near where the LEDs are placed, which improves blood flow in that location.

In some implementations, the tent system may be conveniently used in a user's house and may be portable. (e.g., in some cases, less than 50 lbs.). In other implementations, the tent system may weigh as much as 75 lbs. The tent system may be a one-time purchase and available for repeated use.

In some implementations, the tent system may include hemp or other material capable of being hermetically sealed. In some implementations, the tent system may be a non-microbial environment. In some implementations, Bluetooth or other wireless technology may be implemented into the tent system for controlling the tent system, including the steam source, the light source, and the sound source.

In some implementations, the hemp fabric used in the tent enclosure is formed from bast fibers extracted from the outer stalk of the Cannabis sativa plant (industrial hemp containing less than 0.3% THC). Hemp bast fibers have a porous surface structure and a hollow core lumen approximately 60 to 90 micrometers in diameter that acts as a micro-capillary channel, promoting rapid moisture transport along the fiber length. The porous cross-section of hemp fibers facilitates airflow and moisture wicking, enabling the enclosure to manage humidity generated by the steam source while maintaining a comfortable therapeutic environment for the user.

In some implementations, the hemp fabric exhibits natural antimicrobial and antifungal properties due to its chemical composition. Hemp fibers contain a high concentration of lignin, a complex organic polymer that is resistant to bacteria and other microorganisms. Lignin is hydrophobic, which means that it repels water at the fiber surface level and inhibits bacterial colonization. Hemp fibers also contain pectin, a carbohydrate that has been shown to exhibit antimicrobial properties against a variety of microorganisms including bacteria and fungi. These inherent antimicrobial properties enable the hemp enclosure to resist the growth of mold, mildew, and pathogenic bacteria such as Staphylococcus aureus and Escherichia coli in the warm, humid environment created by the steam source, without requiring chemical antimicrobial treatments applied to the fabric.

In some implementations, the hemp fabric provides moisture-wicking performance characterized by a vertical wicking height of approximately 18 to 22 centimeters in 10 minutes, a moisture absorption time of less than one second for a 100 microliter water droplet, and an air permeability of approximately 350 to 420 cubic feet per minute. These properties enable the hemp enclosure to rapidly absorb and release moisture generated by the steam source, preventing condensation buildup on the interior enclosure walls and maintaining a controlled humidity level within the therapeutic environment. The hemp fabric retains greater than 85 percent of its moisture-wicking capacity after repeated laundering, ensuring sustained performance over the operational life of the enclosure.

In some implementations, the hemp fabric used in the enclosure may be processed using one or more of the following techniques to optimize its properties for the therapeutic environment: liquid ammonium treatment to convert the crystal structure of the hemp fiber from cellulose I into a mixture of cellulose III and cellulose I, thereby improving liquid moisture management properties; enzymatic retting to enhance fiber purity and capillary integrity; or mechanical softening to improve the hand feel and flexibility of the fabric without degrading its antimicrobial or moisture-wicking characteristics. The hemp fabric may have a denier rating selected to balance durability, breathability, and weight for the enclosure application.

In some implementations, the hemp fabric may be blended with other natural or synthetic fibers to achieve specific performance characteristics for the enclosure. For example, a hemp-silk blend may provide enhanced softness while retaining hemp's antimicrobial and moisture-wicking properties. A hemp-cotton blend may improve initial fabric softness while maintaining durability and breathability. In embodiments where the enclosure is formed of a combination of Mylar and hemp, the hemp fabric may form an outer antimicrobial layer while the Mylar forms an inner reflective layer, or the hemp and Mylar may be laminated together into a composite panel construction. The hemp component of any such combination retains its natural antimicrobial, moisture-wicking, and breathability properties.

In some implementations, the tent system may include Mylar or a combination of Mylar and hemp. Mylar provides a reflective interior surface that enhances the efficacy of multispectral light therapy by reflecting emitted light back toward the user, increasing the effective irradiance within the enclosure. When combined with hemp, the enclosure provides both reflective performance and antimicrobial characteristics.

In addition to the antimicrobial characteristics provided by hemp, the Mylar layer provides an interior reflective surface that enhances the efficiency of multispectral light therapy by reflecting emitted therapeutic wavelengths back toward the user. When the Mylar layer is incorporated into a substantially continuous conductive enclosure with appropriate grounding or conductive continuity, the Mylar layer may also function as part of an electromagnetic shielding system that operates similarly to a Faraday cage by attenuating certain external electromagnetic fields and radio-frequency (RF) energy entering the enclosure. The degree of attenuation depends on factors including the enclosure design, material properties, grounding configuration, seams, openings, and the frequency range involved. The electromagnetic shielding functionality is intended to reduce exposure to unwanted external electromagnetic frequencies within the therapeutic environment rather than to completely block all electromagnetic wave frequencies.

In some implementations, the light source may include multiple lights or strips of lights that may be located in various locations in the tent. For example, the light source(s) may be attached hanging from the top of the tent or affixed to the side of the tent. The light source may be attached to the tent by any affixing means (e.g., Velcro, ties, clips, thread, etc.). In other implementations, the light source may be free standing inside the tent.

In some implementations, the light source includes a multispectral light array configured to emit wavelengths in a range of 380 nm to 1100 nm, encompassing the full visible spectrum and near-infrared range. The multispectral light array may include LED arrays capable of emitting light in red, blue, green, violet, cyan, yellow, orange, and infrared ranges. The controller may dynamically select and adjust wavelengths and intensity within this range based on the user's condition and real-time biofeedback.

### DEFINITIONS

The term “tent” refers to a material, housing, or casing that encloses a user and provides a steam room environment. The components of the tent system may be located inside or outside of the tent. For example, a steam source may be located inside or outside of the tent.

The term “hemp fabric” refers to a textile material formed from bast fibers extracted from the stalks of the Cannabis sativa plant (industrial hemp). Hemp fabric is characterized by natural antimicrobial properties attributable to lignin and pectin content, a porous fiber structure with hollow core lumens that promote moisture wicking and breathability, high tensile strength, and resistance to mold, mildew, and ultraviolet degradation. Hemp fabric may be processed by various methods including water retting, enzymatic retting, liquid ammonium treatment, or mechanical softening, and may be woven or knitted in various constructions including plain weave, twill weave, jersey knit, or interlock knit.

The term “steam source” refers to any machine configured for steam production.

The term “light source” refers to LED/Infrared Light. In some implementations, the light will have the red/green/blue spectral range.

The term “sound source” refers to sounds provided within the tent of the tent system that consists of very specific tones and frequency ranges to promote healing and a sense of well-being. A sound source can be one or more sounds, and can include sounds, songs, rhythms, beats and/or melodies that are configured to promote healing and a sense of well-being.

The terms “individual”, “subject”, “patient”, “person,” “listener,” and “user” are used interchangeably herein and refer to any mammalian subject for whom use of the tent system is desired, particularly humans.

The terms “a”, “an”, and “the” refer to embodiments having plural referents, unless the content clearly dictates otherwise. As used in this specification and the appended claims, the term “or” is generally employed in its sense including “and/or” unless the content clearly dictates otherwise.

All ranges set forth herein in the summary and description of the disclosed technology and the claims include all numbers or values thereabout or therebetween of the numbers of the range. The ranges of the disclosed technology expressly denominate and set forth all integers, decimals and fractional values in the range.

The terms “about” and “approximately” in the context of numerical values and ranges refers to values or ranges that approximate or are close to the recited values or ranges such that the disclosed technology can perform as intended, such as having a desired rate, amount, degree or extent of absorption and desensitization, as is apparent from the teachings contained herein. Thus, this term encompasses values beyond those simply resulting from systematic error. By “substantially,” as recognized by the skilled person, it is meant in this and similar contexts that the products and methods are suitable for their intended purpose. The following description provides specific embodiments. It is to be understood that other embodiments are contemplated and may be made without departing from the scope or spirit of the present invention. The following detailed description, therefore, is not to be taken in a limiting sense. While the present invention is not so limited, an appreciation of various aspects of the invention will be gained through a discussion of the examples provided below.

The term “treating” in its various grammatical forms in relation to the present disclosed technology refers to, depending on context, avoiding, preventing, curing, reversing, attenuating, alleviating, minimizing, suppressing or halting the deleterious effects of a physical, emotional, or psychological condition, illness, disease state, disease progression, disease causative agent or other abnormal or undesired condition, as recognized by the skilled person or a person in need of treatment. In one implementation of the disclosed technology, burns are treated.

The term “adaptive controller” refers to a computing device or processor programmed with machine-learning algorithms that receives biofeedback data from sensors, processes the data to determine an appropriate treatment, protocol, or program for a therapeutic response, and outputs control signals to adjust environmental parameters of the tent system per the determined treatment, protocol, or program.

The term “machine-learning algorithms” refers to computational methods that improve their performance on a task through experience, including but not limited to supervised learning, unsupervised learning, reinforcement learning, deep learning neural networks, and combinations thereof. The machine-learning algorithms process data received from the sensors to determine an appropriate treatment, protocol, or program for the user.

The machine-learning algorithms may include neural networks that utilize algorithmic computations derived from one or more users' physiological profiles. These algorithms may compare, correlate, and learn from accumulated user data to improve predictive therapeutic responses. In some implementations, the system may simultaneously analyze anonymized physiological data from multiple users to improve adaptive treatment accuracy while maintaining individualized therapy protocols.

The term “resonance profiles” refers to stored data representations of target physiological states, wherein each profile defines target values or ranges for one or more biometric parameters corresponding to a desired therapeutic outcome.

The term “biofeedback signals” refers to measurable physiological signals from a user, including but not limited to electrical cardiac activity (ECG), electrical brain activity (EEG), electrodermal activity or galvanic skin response (GSR), and body temperature. The biofeedback signals are received by the adaptive controller and used to determine the course of treatment, protocol, or program for the user.

The term “continuously calibrates” refers to an ongoing process by which the adaptive controller updates its internal models and parameters during and between therapeutic sessions based on newly acquired biofeedback data from the sensors, without requiring manual intervention. This continuous calibration enables the adaptive controller to refine the determined treatment, protocol, or program as the user's condition changes.

The term “continuously calibrates” further includes neural-network-based adaptation, wherein AI continuously refines therapeutic parameters based upon real-time biofeedback, accumulated historical data, and synchronized network interactions with one or more participating users. The adaptive controller dynamically adjusts treatment protocols to improve coherence and therapeutic synchronization across connected users.

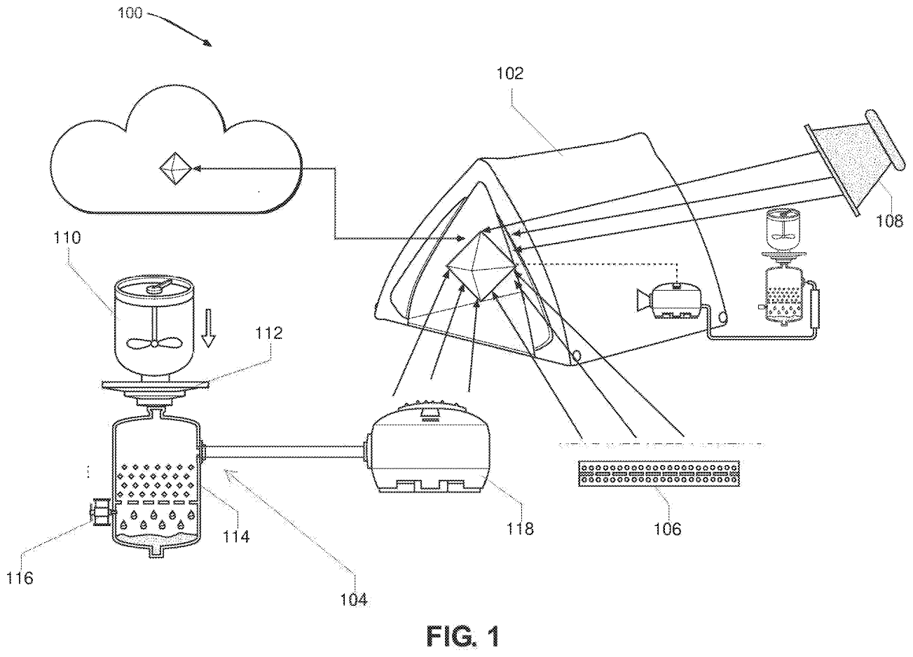

FIG. 1 illustrates a schematic diagram of a tent system 100 in accordance with aspects in the present disclosure. The tent system 100 includes four main components: a tent 102, a steam source 104, a light source 106, and a sound source 108. In the tent system 100 in FIG. 1, the tent 102 is made of hemp fabric. In other implementations, other fabrics may be used. The tent fabric may be configured to be hermetically sealed and provide an anti-microbial environment.

The steam source 104 shown in FIG. 1 includes a water tank 110 with a filter 112. The water may be placed in the water tank 110 and filtered to a pressurized steam generator 114, which includes a tank release 116. Air and water vapor move to a removable overflow tank 118 and steam is provided into the tent 102.

In one implementation, the steam source 104 may be a Wagner 715 Power Steamer® with a 1-gallon tank and a 1500-Watt heating element that provides up to 70 minutes of steam time from one fill. The unit's specifications are 120V for the Wagner 715 Power Steamer®, 60 HZ and 1500 W×2 for the heating element. The assembled product dimensions are (L×W×H) 14.00×14.00×14.00 Inches. The mini-max steam temperature is in a range from 102-120 Fahrenheit, and humidity approximately 100. Pre-heating time may take approximately 20 minutes and can vary. In some implementations, the steam source 104 may be adapted for a 110 volt outlet. In other implementations, the steam source may be adapted for two 110-watt outlets. Other steam sources are contemplated.

A light source is located in the tent. In FIG. 1, the light source 106 is near infrared lighting. In other implementations, other light sources may be used.

Different color light may be selected based on the treatment desired for a particular user's condition. For example, infrared light (850 nm) and red light (660 nm) may be used to penetrate tissue to a depth of about 8-10 mm to help promote blood circulation and the relaxation of muscles, enhance immunity, stimulate metabolism, produce new collagen and provide an overall healthy, radiant and more even toned and younger looking complexion. Infrared light (850 nm) and red light (660 nm) may also be used to increase collagen production fivefold in the skin, triggering repair mechanism and stimulating fibroblast cells and cell growth.

In another example, blue light (415 nm) may be used to improve acne prone skin with its purifying and antibacterial properties. It effectively reduces the amount of fluid in the face and treats sensitive skin to provide a clear complexion.

In another example, green light (525 nm) may be used to reduce pigmentation through penetration into base skin layers, prevents the formation of fleck, gravid and aging pigment to keep skin smooth and bright.

Example optimal light intensity ranges for cells are at color/wavelength 0.1 J/cm² to 6 J/cm². Example LED/Lamp side watts are:
1. Time=Dose÷(Power density×0.001); and
2. LED Light Colors: Green, Blue, Red, Violet.

Additional guidance for selection of a specific light source used in a particular tent depending on the desired treatment is provided in the following chart: The color of the lighting may be adjusted according to the desired result. For example, red may be selected for younger looking skin and decreased signs of aging including reduction of fine lines and wrinkles by increasing collagen production. Additionally, violet may be selected to increase cell regeneration to cleanse the skin and reduce inflammation. Blue may also be selected to reduce acne and whiten teeth because blue light reduces the bacteria that causes acne and may whiten teeth. Cyan may be selected to smooth skin because it is a smoothing, calming, and heating treatment that helps reduce irritation and inflammation in skin. Green may be selected to promote an even complexion because green light balances out redness and blotches for naturally beautiful skin. Yellow may be selected to reduce redness because yellow light alleviates inflammation, sunburn, rosacea, and/or other skin conditions. Orange may be selected to enhance the user's glow from within because orange light revitalizes your skin for a brighter glow and adds radiance and vitality to dull skin. Finally, infrared light may be selected to penetrate deeper into the skin. Moreover, any combination of colors may be selected to tailor the treatment to the user's needs.

A 432 Hz sound source is provided in the tent in FIG. 1.

In some implementations, the following example parameters are included for the sound source:
Signal-to-noise ratio. SPL: 60-70 DB.
Transducer: 1×40 mm.
Dimensions: (H×W×D) 141×94×42 (mm).
Weight: 184 g.
Control and Connection Specifications:
Bluetooth version 4.2.
Bluetooth transmitter power 0-9 dBm.
Bluetooth transmitter frequency range 2.402-2.480 GHz.
Bluetooth transmitter modulation GFSK, π/4 DQPSK, 8DPSK.

Combining specific sounds in/with music will be programmable and customized for specific therapeutic sessions. 432 Hz is the harmonic intonation of nature. Playing and listening to music that has been tuned to 432 Hz can make a listener's body, and the organic world which surrounds the body, resonate in a natural way. As a result, the listener may be filled with a sense of peace and well-being, regardless of the kind of song chosen. Providing music that has been tuned to the “scientific” 432 Hz frequency may benefit a listener, whereas listening to music tuned to the “disharmonic” 440 Hz frequency harms a listener by causing stress, negative behaviors, and unstable emotions. Listening to 432 Hz music resonates inside a body, releases emotional blockages, and expands consciousness.

Combining sound with steam and light within the hermetically sealed tent of the tent system enhances each variable's unique healing potential.

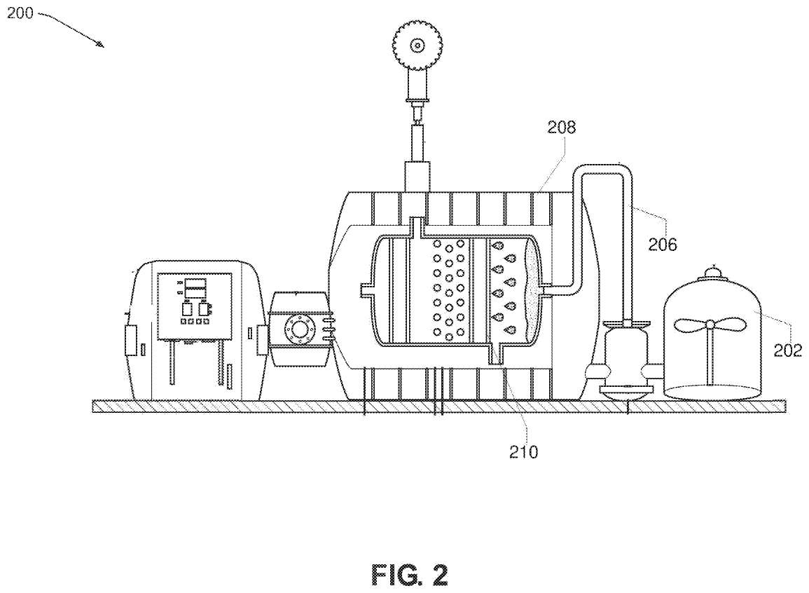

FIG. 2 illustrates a schematic diagram of a steam source 200 in accordance with aspects in the present disclosure. The steam source 200 shown in FIG. 2 includes a water tank 202 with a filter. The water may be placed in the water tank 202 and filtered through a water feed line 206 to a second water tank 208, which includes an external heater coil 210. Steam is created and moves into the tent 102.

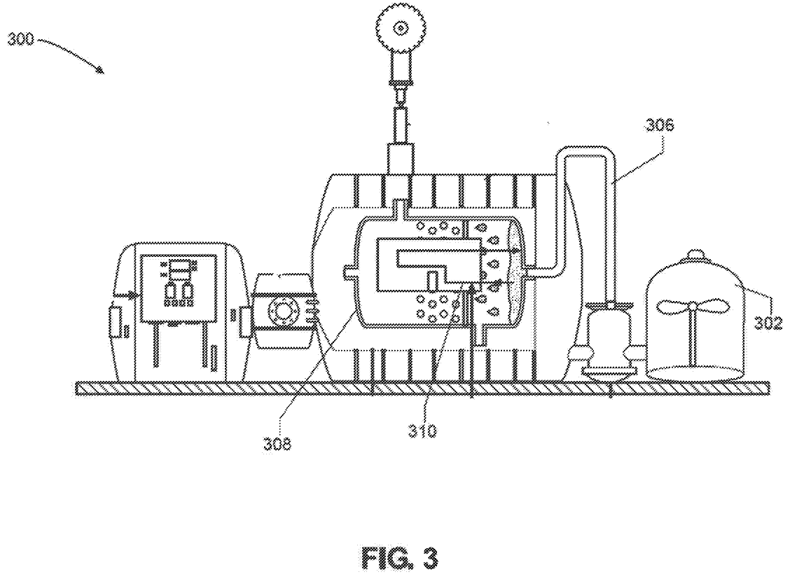

FIG. 3 illustrates a schematic diagram of a steam source 300 in accordance with aspects in the present disclosure. The steam source 300 shown in FIG. 3 includes a water tank 302 with a filter. The water may be placed in the water tank 302 and filtered through a water feed line 306 to a second water tank 308, which includes an internal heater coil 310. Steam is created and moves into the tent 102.

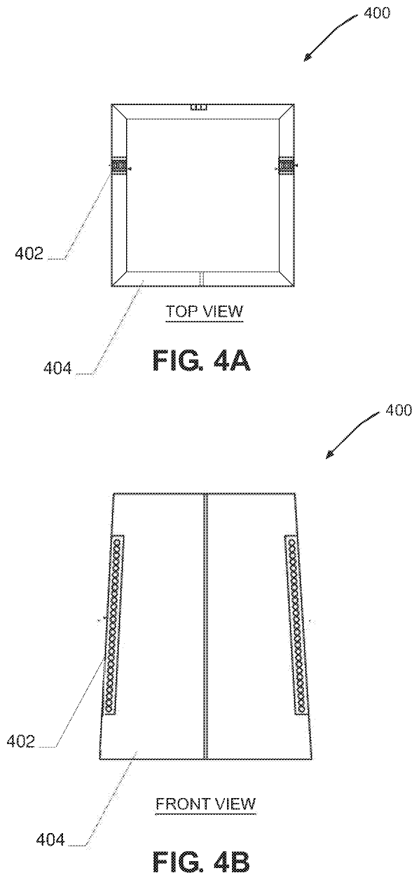

FIGS. 4A and 4B illustrates schematic diagrams of a top view and a front view of a tent system 400 in accordance with aspects in the present disclosure. A light source 402 (LED lighting) is shown in a tent 404.

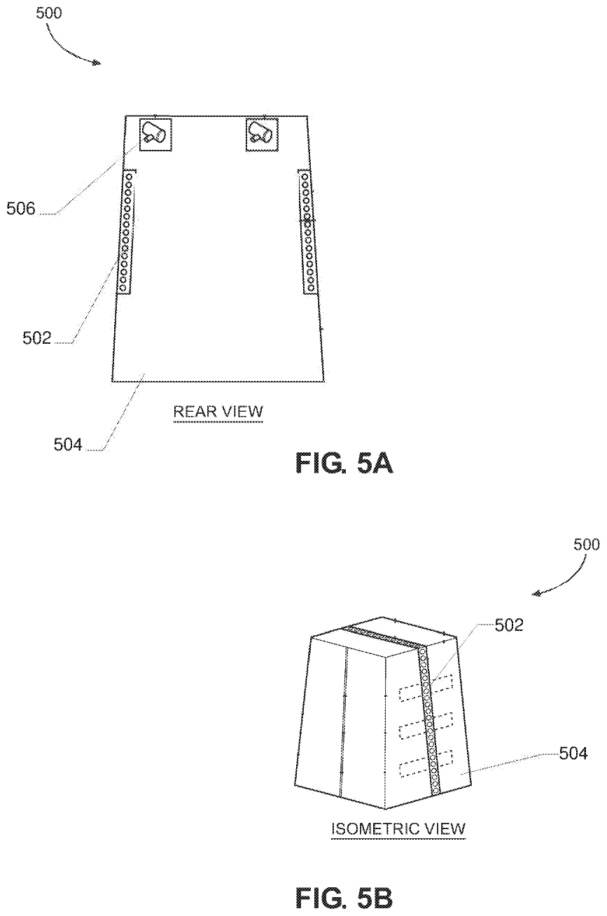

FIGS. 5A and 5B illustrates schematic diagrams of a rear view and an isometric view of a tent system 500 in accordance with aspects in the present disclosure. A light source 502 (LED lighting in a strip (4 w/3 k/55)) is shown in the tents 504, secured by Velcro fasteners. Stereo speakers 506 (A432) IP67/68 rated) are shown as part of a sound source.

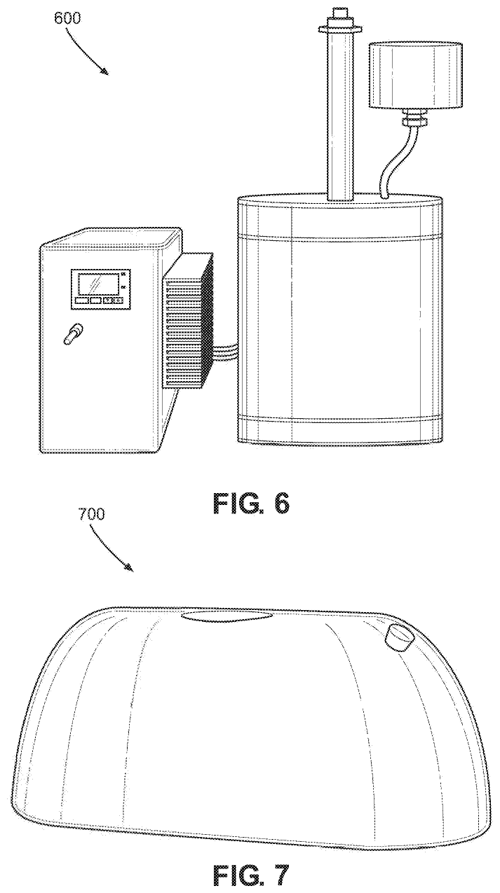

FIG. 6 is a perspective view of a steam source 600 of a tent system in accordance with aspects in the present disclosure. The steam source 600 is adapted for one 110-watt outlet. In other implementations, the steam source 600 is adapted for two 110-watt outlets.

FIG. 7 illustrates an image of a steam source 700 of a tent system in accordance with aspects in the present disclosure. The steam source 700 is a steam unit shell concept design.

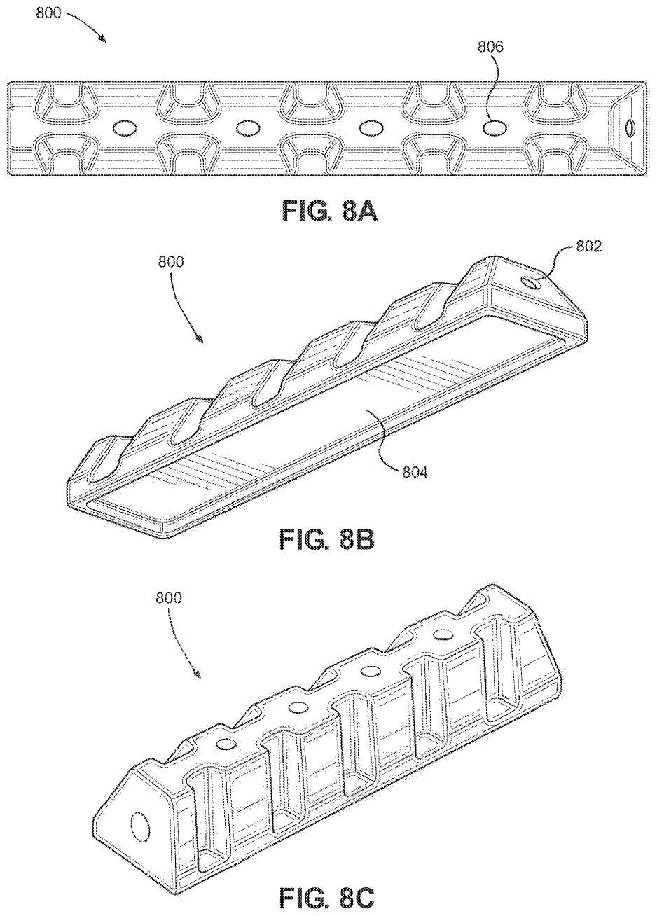

FIGS. 8A-C are schematic diagrams of a steam source 800 of a tent system in accordance with aspects in the present disclosure. The steam source 800 is a steam dispenser unit concept design including a steam intake 802, a removable dispenser overflow catch tray 804, and an adjustable direction steam output valve 806.

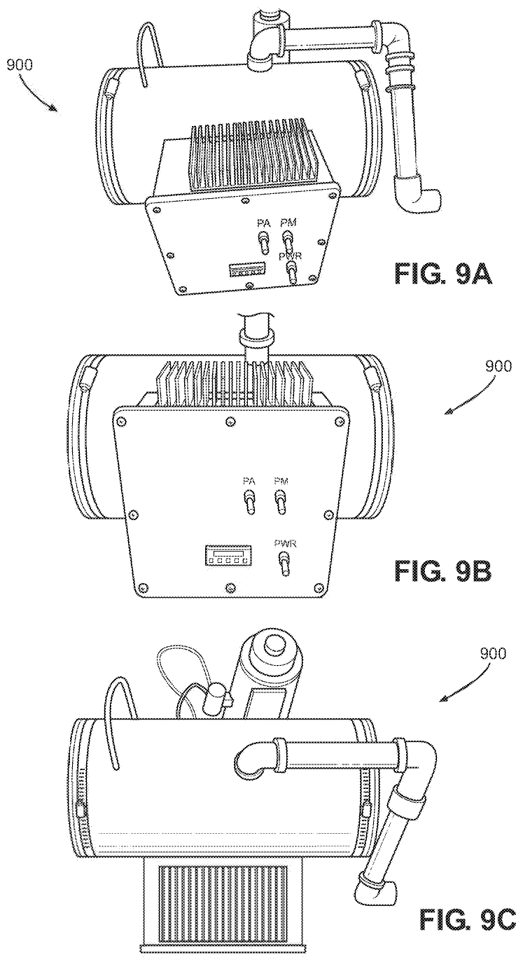

FIGS. 9A-C are perspective views of a steam source 900 of a tent system in accordance with aspects in the present disclosure.

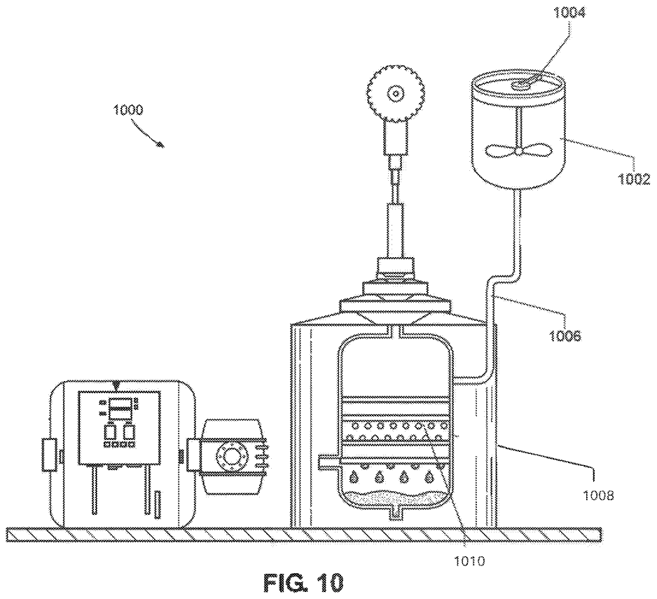

FIG. 10 illustrates a schematic diagram of a steam source 1000 in accordance with aspects in the present disclosure. The steam source 1000 shown in FIG. 10 includes a water tank 1002 with a filter 1004. The water may be placed in the water tank 1002 and filtered through a water feed line 1006 to a second water tank 1008, which includes an internal heater coil 1010. Steam is created and moves into the tent.

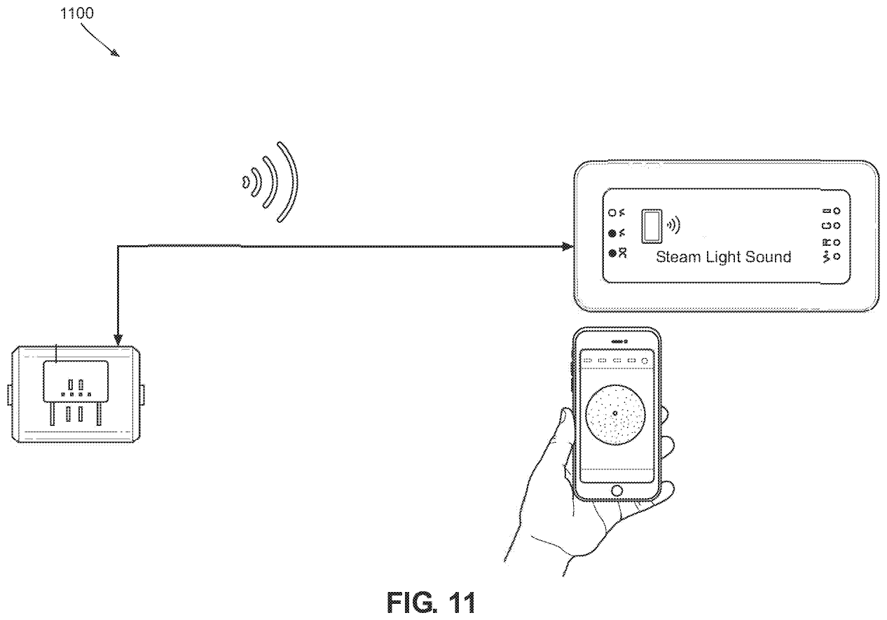

FIG. 11 illustrates a schematic flow diagram of a control system 1100 in accordance with aspects in the present disclosure. The control system 1100 includes Bluetooth or other wireless technology for controlling the tent system, including the steam source, the light source, and the sound source. The control system 1100 may include at least Bluetooth version 4.2 having a transmission power of at least 0-9 dBm, a transmitter frequency range of at least 2.402-2.480 GHz, and a transmitter modulation of at least GFSK, π/4 DQPSK, and/or 8DPSK.

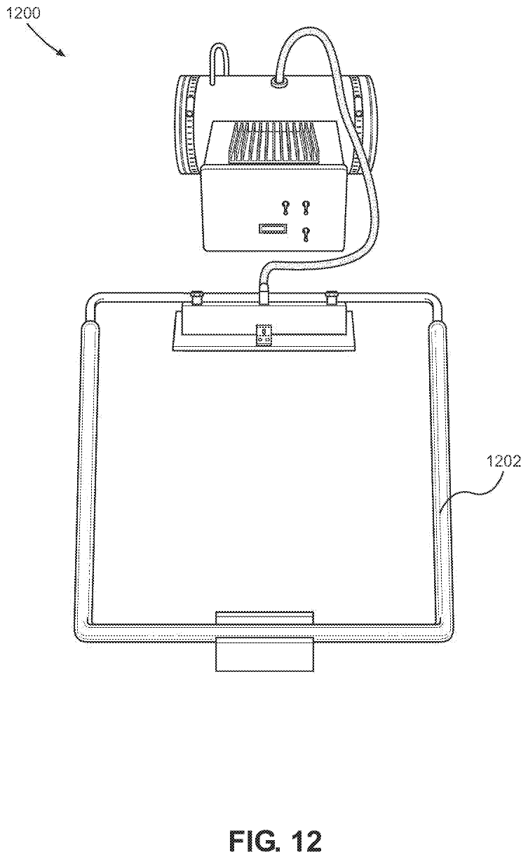

FIG. 12 is schematic diagrams of a steam source 1200 of a tent system in accordance with aspects in the present disclosure. The steam source 1200 is a contoured steam dispenser unit concept design including steam output valves 1202.

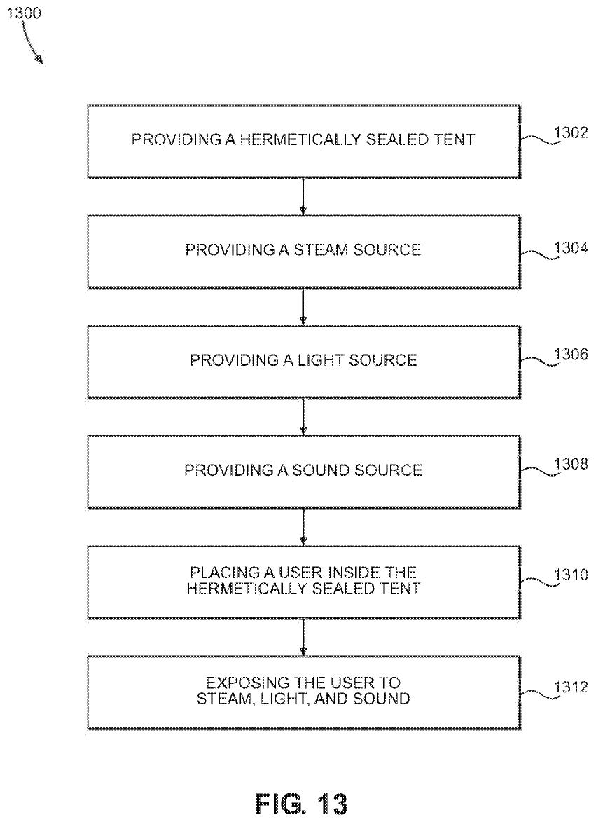

FIG. 13 is a flowchart of example operations 1300 of a method of using a tent system. An operation 1302 provides a hermetically sealed tent. An operation 1304 provides a steam source. An operation 1306 provides a light source. An operation 1308 provides a sound source. An operation 1310 places a user inside the hermetically sealed tent. An operation 1312 exposes the user to steam, light, and sound.

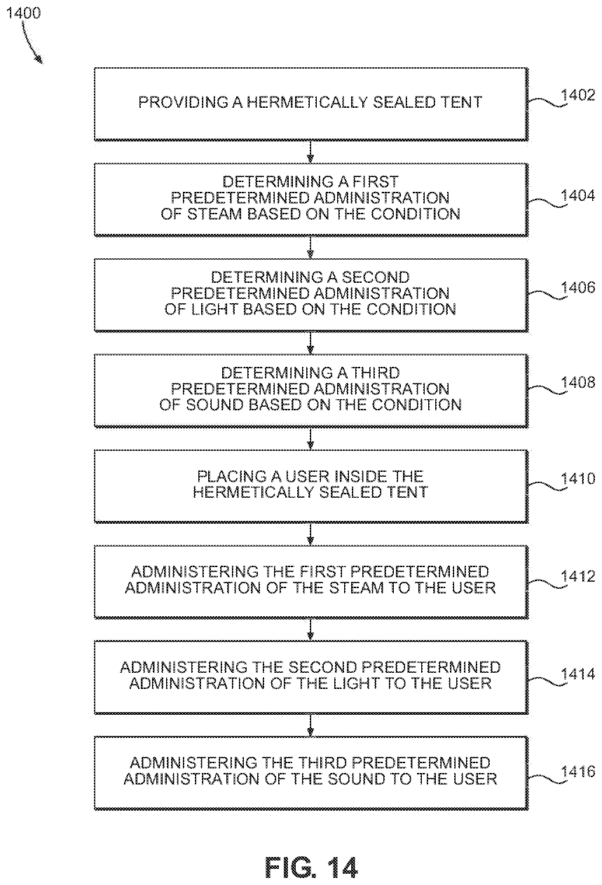

FIG. 14 is a flowchart of example operations 1400 of a method of treatment of a condition. An operation 1402 provides a hermetically sealed tent. In some implementations, the tent may be made of hemp or other materials capable of providing a hermetically sealed and anti-microbial environment.

The hermetically sealed tent includes a steam source, a light source, and a sound source. An operation 1404 provides determining a first predetermined administration of steam based on the condition. The first predetermined administration of steam may include a certain amount of steam to be administered to a tent system user. The first predetermined administration of steam may include a certain amount of time that the steam will be administered. The amount of steam and the amount of time the steam is provided may be based on the condition of the user.

An operation 1406 provides determining a second predetermined administration of light based on the condition. The second predetermined administration of steam may include the type of light administered and the amount of time the light is provided, which may or may not be the same amount of time as the steam or sound administration.

An operation 1408 provides determining a third predetermined administration of sound based on the condition. The third predetermined administration of sound may include the type of sound administered and the amount of time the sound is provided, which may or may not be the same amount of time as the steam or light administration.

For example, the setting of steam, light, and sound may be based on the following Tables 1 and 2:

TABLE 1

| | | | STEAM | HEALTH |
|---|---|---|---|---|
| PRESCRIPTION | SOUND | LIGHT | TIME | BENEFITS |
| PRESCRIPTION 1 | A432 - Binary | Red light - | 10-15 | Increases alertness, |
| | Beats - | 600 nm-700 | Minutes | memory & |
| | A432@486 Hz | nm | | cognitive function, |
| | | | | blood circulation to |
| | | | | the skin and |
| | | | | collagen |
| | | | | production. Red |
| | | | | Light: |
| | | | | Infrared light |
| | | | | (850 nm) and red |
| | | | | light (660 nm): |
| | | | | penetrates tissue to |
| | | | | a depth of about 8- |
| | | | | 10 mm to help |
| | | | | promote blood |
| | | | | circulation and the |
| | | | | relaxation of |
| | | | | muscles, enhances |
| | | | | immunity, |
| | | | | stimulates |
| | | | | metabolism, |
| | | | | increases collagen |
| | | | | production fivefold |
| | | | | in the skin, |
| | | | | triggering repair |
| | | | | mechanism and |
| | | | | stimulating |
| | | | | fibroblast cells and |
| | | | | cell growth. |
| PRESCRIPTION 2 | A432 - Binary | Blue Light - | 15-20 | Stimulates upper |
| | Beats - | 415 nm to | Minutes | dermal skin relief, |
| | A432@306 Hz | 470 nm | | minimizes |
| | | | | scarring, reduces |
| | | | | rashes, decreases |
| | | | | depression |
| PRESCRIPTION 3 | A432 - Binary | Green | 15-20 | Reduces migraine |
| | Beats - | 252 nm | Minutes | headaches, pain, |
| | A432@342 Hz | | | and the need for |
| | | | | opioids - Calms |
| | | | | and tightens skin |
| PRESCRIPTION 4 | A432 - Binary | Orange | 15-20 | Increases blood |
| | Beats - | 610 nm | Minutes | flow and |
| | A432@432 Hz | | | metabolism |
| PRESCRIPTION 5 | A432 - Binary | Yellow | 15-20 | Fades dark spots, |
| | Beats - | 590 nm | Minutes | freckles and |
| | A432@204 Hz | | | blemishes. |
| | | | | Increases wound |
| | | | | healing, collagen |
| | | | | induction, skin |
| | | | | hydration and the |
| | | | | overall health of |
| | | | | the skin |
| PRESCRIPTION 6 | A432 - Binary | White 40 hz | 15-20 | Light and sound |
| | Beats - | Flicker | Minutes | delivered at a |
| | A432@40 Hz | | | certain |
| | | | | frequency—40 |
| | | | | flashes or |
| | | | | clicks per |
| | | | | second—appear |
| | | | | to restart |
| | | | | the natural 40 Hz |
| | | | | gamma rhythm of |
| | | | | the brain, improve |
| | | | | the brain functions |
| | | | | and diminish toxic |
| | | | | levels of |
| | | | | Alzheimer's-related |
| | | | | proteins. Listening |
| | | | | to a 40-Hz binaural |
| | | | | beat for 20 minutes |
| | | | | enhances working |
| | | | | memory function. |
| | | | | Gamma and beta |
| | | | | oscillations are |
| | | | | induced by 40-Hz |
| | | | | binaural beats at |
| | | | | the temporal and |
| | | | | frontal regions. |
| | | | | Emotional states of |
| | | | | the participants |
| | | | | have been known |
| | | | | to change. |
| PRESCRIPTION 7 | A432 - Binary | Red light - | | LED Red Light: |
| Combination LED | Beats - | 600 nm-700 | | Increases alertness, |
| Therapy | A432@486 Hz | nm | | memory & |
| | | | | cognitive function, |
| | | | | increase blood |
| | | | | circulation to skin) |
| | | | | and Increases |
| | | | | collagen |
| | | | | production. |
| | | | | Infrared light |
| | | | | (850 nm) and red |
| | | | | light (660 nm): |
| | | | | penetrates tissue to |
| | | | | a depth of about 8- |
| | | | | 10 mm to help |
| | | | | promote blood |
| | | | | circulation and the |
| | | | | relaxation of |
| | | | | muscles, enhances |
| | | | | immunity, |
| | | | | stimulates |
| | | | | metabolism, |
| | | | | increases collagen |
| | | | | production fivefold |
| | | | | in the skin, |
| | | | | triggering repair |
| | | | | mechanism and |
| | | | | stimulating |
| | | | | fibroblast cells and |
| | | | | cell growth. |
| | 486 Hz A432 - | Blue Light - | | Stimulates upper |
| | Binary Beats - | 415 nm to | | dermal skin relief, |
| | A432@306 | 470 nm | | minimizes |
| | | | | scarring, reduces |
| | | | | rashes, decreases |
| | | | | depression |
| PRESCRIPTION 8 | A432 - Binary | Red light - | | LED Red Light: |
| Combination LED | Beats - | 600 nm-700 | | Increases alertness, |
| Therapy | A432@486 Hz | nm | | memory & |
| | | | | cognitive function, |
| | | | | increase blood |
| | | | | circulation to skin) |
| | | | | and Increases |
| | | | | collagen |
| | | | | production. |
| | | | | Infrared light |
| | | | | (850 nm) and red |
| | | | | light (660 nm): |
| | | | | penetrates tissue to |
| | | | | a depth of about 8- |
| | | | | 10 mm to help |
| | | | | promote blood |
| | | | | circulation and the |
| | | | | relaxation of |
| | | | | muscles, enhances |
| | | | | immunity, |
| | | | | stimulates |
| | | | | metabolism, |
| | | | | increases collagen |
| | | | | production fivefold |
| | | | | in the skin, |
| | | | | triggering repair |
| | | | | mechanism and |
| | | | | stimulating |
| | | | | fibroblast cells and |
| | | | | cell growth. |
| | A432 - Binary | Green | 15-20 | Reduces migraine |
| | Beats - | 252 nm | Minutes | headaches, pain, |
| | A432@342 Hz | | | and the need for |
| | | | | opioids - Calms |
| | | | | and tightens skin |

TABLE 2

| Frequen- | Tonal | Wave | | Spectrum | Copyrighted |
|---|---|---|---|---|---|
| cy Hz | Key | Frequency | Benefits | Color | Music |
| A432 | D 324 | Sine Wave | Decrease in | Blue Light - | All music and |
| | Hz | | depression | 415 nm to | sounds are |
| | | | | 470 nm | specifically |
| | | | | | designed, created |
| | | | | | and produced to |
| | | | | | target each |
| | | | | | individual and/or |
| | | | | | combination |
| | | | | | prescriptive |
| | | | | | approach. The |
| | | | | | combination of |
| | | | | | A432 Frequency, |
| | | | | | Pitch, and Binary |
| | | | | | beats will differ in |
| | | | | | range from 40 |
| | | | | | beats per min to |
| | | | | | 180 beats per min. |
| | | | | | The specific |
| | | | | | targeted utilization |
| | | | | | of instrumentation |
| | | | | | will treat the |
| | | | | | binary beats as a |
| | | | | | contrapuntal |
| | | | | | foundation to the |
| | | | | | accompanying |
| | | | | | rhythmical, |
| | | | | | melodic, and |
| | | | | | harmonic pattern. |
| A432 | F 342 | Sine Wave | Migraine | Green | |
| | Hz | | headaches, | 252 nm | |
| | | | pain, opioids - | | |
| | | | Calms and | | |
| | | | tightens skin | | |
| A432 | D 486 | Sine Wave | Decrease in | Red light - | |
| | Hz | | PTSD | 60 nm | |
| | | | (Alertness, | | |
| | | | memory & | | |
| | | | cognitive | | |
| | | | function, skin) | | |
| | | | Increases blood | | |
| | | | flow and | | |
| | | | collagen | | |
| | | | production. | | |
| A432 | G 204 | Sine Wave | Fades dark | Yellow | |
| | Hz | | spots, freckles | 590 nm | |
| | | | and blemishes, | | |
| | | | increases | | |
| | | | wound healing, | | |
| | | | collagen | | |
| | | | induction, skin | | |
| | | | hydration and | | |
| | | | the overall | | |
| | | | health of the | | |
| | | | skin | | |
| A432 | A 432 | Sine Wave | Increases blood | Orange | |
| | Hz | | flow and | 610 nm | |
| | | | metabolism | | |

In some implementations, the tent system may not have one variable, such as light or sound. Once it is determined what steam, light, and/or sound will be provided in the tent system, an operation 1410 places a user inside the hermetically sealed tent for treatment. An operation 1412 administers the first predetermined administration of the steam to the user. An operation 1414 administers the second predetermined administration of the light to the user. An operation 1416 administers the third predetermined administration of the sound to the user. In some implementations, the determined second predetermined administration of the light is selected from LED/infrared light.

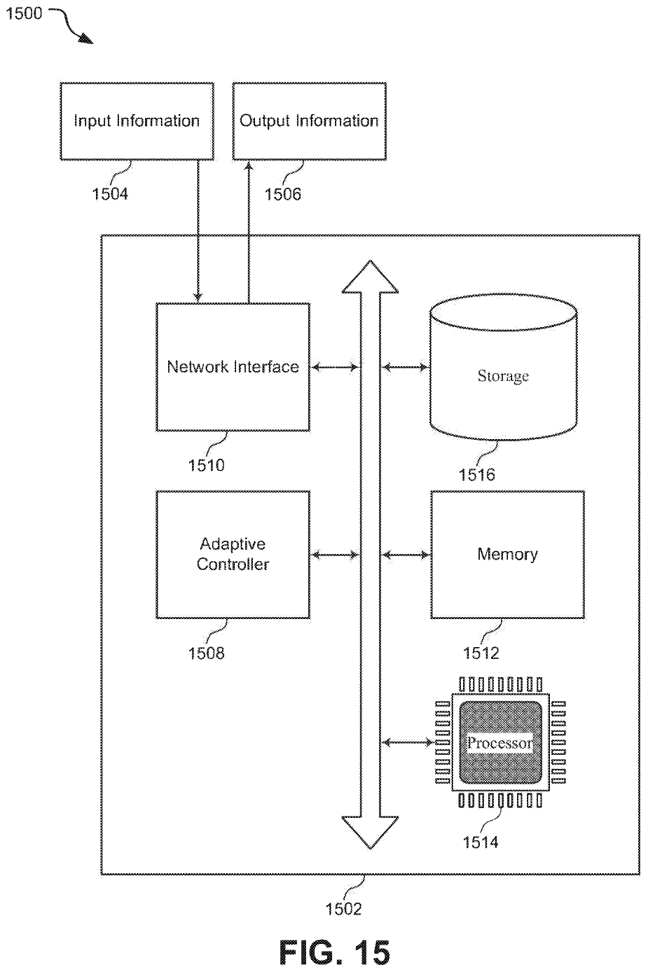

FIG. 15 shows a diagram of a system 1500 including a device 1502 that supports an adaptive controller for a therapeutic tent system in accordance with aspects of the present disclosure. The device 1502 may include components for bi-directional data communications including components for transmitting and receiving communications, such as an adaptive controller 1508, an input information 1504, an output information 1506, a network interface 1510, at least one memory 1512, at least one processor 1514, and a storage 1516. These components may be in electronic communication or otherwise coupled (e.g., operatively, communicatively, functionally, electronically, electrically) via one or more buses (e.g., communication links, communication interfaces, or any combination thereof).

The network interface 1510 may enable the device 1502 to exchange information (e.g., input information 1504, output information 1506, or both) with other systems or devices (not shown). For example, the network interface 1510 may enable the device 1502 to connect to a network. The network interface 1510 may include one or more wireless network interfaces, one or more wired network interfaces, or any combination thereof.

Memory 1512 may include RAM, ROM, or both. The memory 1512 may store computer-readable, computer-executable software including instructions that, when executed, cause at least one processor 1514 to perform various functions described herein, such as functions supporting the adaptive controller of the tent system. In some cases, the memory 1512 may contain, among other things, a basic input/output system (BIOS), which may control basic hardware or software operation such as the interaction with peripheral components or devices. The memory 1512 may be an example of a single memory or multiple memories. For example, the device 1502 may include one or more memories 1512.

The processor 1514 may include an intelligent hardware device (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1514 may be configured to execute computer-readable instructions stored in at least one memory 1512 to perform various functions (e.g., functions or tasks supporting the adaptive controller of the tent system). Though a single processor 1514 is depicted in the example of FIG. 15, it is to be understood that the device 1502 may include any quantity of one or more processors 1514 and that a group of processors 1514 may collectively perform one or more functions ascribed herein to a processor, such as the processor 1514. The processor 1514 may be an example of a single processor or multiple processors. For example, the device 1502 may include one or more processors 1514.

Storage 1516 may be configured to store data that is generated, processed, stored, or otherwise used by the device 1502. In some cases, the storage 1516 may include one or more HDDs, one or more SSDs, or both. In some examples, the storage 1516 may be an example of a single database, a distributed database, multiple distributed databases, a data store, a data lake, or an emergency backup database.

For example, the adaptive controller 1508 may be configured as or otherwise support a means for receiving biofeedback signals from one or more biofeedback sensors. The adaptive controller 1508 may be configured as or otherwise support a means for correlating, using machine-learning algorithms, the biofeedback signals with stored resonance profiles. The adaptive controller 1508 may be configured as or otherwise support a means for determining a therapeutic adjustment based at least in part on correlating the biofeedback signals with the stored resonance profiles. The adaptive controller 1508 may be configured as or otherwise support a means for automatically adjusting at least one of steam temperature, steam humidity, light wavelength, light intensity, sound frequency, and sound amplitude based at least in part on the determined therapeutic adjustment. The adaptive controller 1508 may be configured as or otherwise support a means for generating one or more predictive healing sequences combining steam, light, and sound cycles. The adaptive controller 1508 may be configured as or otherwise support a means for storing therapy data generated during a user session and transmitting the therapy data to a remote system via encrypted cloud connectivity.

The adaptive controller may additionally correlate physiological data among multiple online users to generate synchronized therapeutic sessions. The AI may evaluate heart-rate variability, EEG, GSR, temperature, light exposure, steam parameters, and sound profiles to promote physiological coherence among participating users. The controller continuously adjusts steam, humidity, multispectral light, and sound parameters based upon individual biofeedback while simultaneously optimizing group synchronization.

In certain implementations, the system generates synchronization metrics representing algorithmic coherence among participating users. These synchronization metrics may include heart-rate synchronization, EEG coherence, synchronized sound modulation, synchronized light modulation, steam synchronization, and composite biofeedback indices. The synchronization data may be securely transmitted to cloud storage where AI algorithms continuously refine predictive therapeutic protocols. In certain implementations, gamification elements may be incorporated to encourage user participation, therapeutic progression, and long-term adherence. The synchronized therapeutic environment may facilitate increased neuroplasticity and promote enhanced gamma-frequency brain activity associated with cognitive performance, meditation, and healing.

By including or configuring the adaptive controller 1508 in accordance with examples as described herein, the device 1502 may support techniques for improved therapeutic accuracy, reduced control loop latency, improved user experience, and improved coordination between components of the tent system, among other examples.

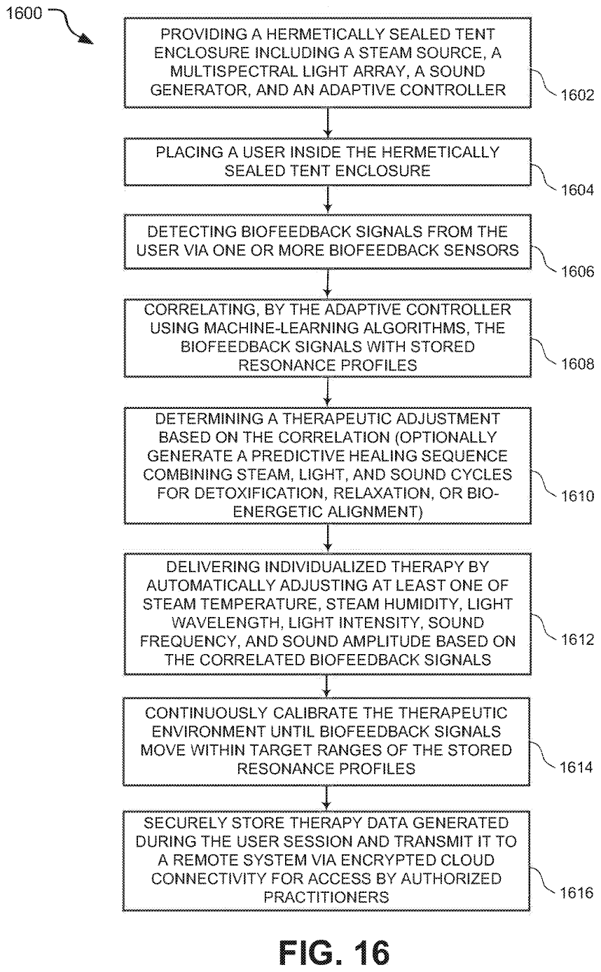

FIG. 16 is a flowchart of example operations 1600 of a method of using a tent system having an adaptive controller in accordance with aspects of the present disclosure. An operation 1602 provides a hermetically sealed tent enclosure including a steam source, a multispectral light array, a sound generator, and an adaptive controller. An operation 1604 places a user inside the hermetically sealed tent enclosure. An operation 1606 detects biofeedback signals from the user via one or more biofeedback sensors. An operation 1608 correlates, by the adaptive controller using machine-learning algorithms, the biofeedback signals with stored resonance profiles.

An operation 1610 determines a therapeutic adjustment based on the correlation and, in some implementations, generates a predictive healing sequence combining steam, light, and sound cycles optimized for a therapeutic outcome such as detoxification, relaxation, or bio-energetic alignment. An operation 1612 delivers individualized therapy by automatically adjusting at least one of steam temperature, steam humidity, light wavelength, light intensity, sound frequency, and sound amplitude based on the correlated biofeedback signals. An operation 1614 continuously calibrates the therapeutic environment by monitoring the biofeedback signals in real time and iteratively repeating operations 1606 through 1612 until the biofeedback signals move within target ranges of the stored resonance profiles. An operation 1616 securely stores therapy data generated during the user session and transmits the therapy data to a remote system via encrypted cloud connectivity for access by authorized practitioners.

By way of example, in some implementations, red light may be selected if the condition includes at least one of muscle, immunological, metabolic, skin, and blood circulation conditions. In some implementations, blue light may be selected if the condition includes at least one of skin and fluid conditions. In some implementations, green light may be selected if the condition includes skin conditions. In some implementations, the third predetermined administration of the sound is providing sound at 432 Hz.

In some implementations, the adaptive controller generates predictive healing sequences by combining steam, light, and sound cycles optimized for specific therapeutic outcomes including detoxification, relaxation, and bio-energetic alignment. The controller may learn from accumulated biofeedback data over multiple sessions to evolve treatment protocols and adaptively adjust baseline parameters as the user's condition changes over time. Longitudinal outcome data may be tracked and made available to practitioners for clinical assessment.

In some implementations, therapy data generated during user sessions are securely stored and accessible to authorized practitioners via encrypted cloud connectivity. The cloud-based storage enables remote monitoring of treatment progress, multi-session trend analysis, and practitioner oversight of the adaptive treatment protocols. Communication between the tent system and the cloud may be encrypted using industry-standard encryption protocols.

In certain implementations, multiple therapeutic systems may be connected through a secure network, allowing anonymized physiological synchronization data to be exchanged among participating users. As additional users join the network, AI algorithms may evaluate aggregate physiological patterns to increase therapeutic synchronization, community coherence, and adaptive optimization while maintaining privacy protections.

In some implementations, the adaptive controller includes safety protocols. First, the adaptive controller may activate automatic shutoff triggers upon detection of abnormal biofeedback signals such as excessive heart rate, dangerously elevated body temperature, or user distress signals. Second, the adaptive controller may measure, detect, or sense when steam temperature or humidity reaches maximum thresholds and activate automatic shutoff triggers to prevent unsafe conditions within the enclosure. Third, an emergency override mechanism may be provided to allow the user to manually terminate a session and exit the enclosure at any time.

In some implementations, the tent system includes a user interface comprising a mobile or tablet-based application for session configuration, real-time monitoring, and session history review. The application may communicate with the adaptive controller via wireless connectivity to allow a user to select treatment prescriptions, adjust parameters during a session, and review past session outcomes. A practitioner dashboard may also be provided for remote monitoring and clinical oversight of one or more tent systems.

In some implementations, the tent system includes one or more biofeedback sensors configured to detect biometric and energetic responses of the user. The biofeedback sensors may include electrocardiogram (ECG) sensors for detecting cardiac activity, electroencephalogram (EEG) sensors for detecting neural activity, galvanic skin response (GSR) sensors for detecting autonomic nervous system activity, and temperature sensors for detecting body temperature. The sensors may be wearable sensors worn by the user, sensors embedded within the tent structure, or external sensors positioned within the tent enclosure. Data from the biofeedback sensors is transmitted to the adaptive controller for real-time analysis and treatment adjustment.

In some implementations, the sound source includes speakers or transducers configured to emit programmable tones across a frequency range of 1 Hz to 20 kHz. The sound source may generate Solfeggio frequencies including 174 Hz, 285 Hz, 396 Hz, 417 Hz, 528 Hz, 639 Hz, 741 Hz, 852 Hz, and 963 Hz. Each Solfeggio frequency may be associated with specific therapeutic benefits and may be selected by the controller based on the user's condition and biofeedback response.

In some implementations, ECG signals are acquired using standard electrode configurations and processed using bandpass filtering (0.5-100 Hz) to extract R-R intervals for heart rate variability analysis. EEG signals are acquired using scalp electrodes and processed using independent component analysis (ICA) for artifact removal, followed by fast Fourier transform (FFT) or wavelet decomposition to extract frequency band powers (delta: 0.5-4 Hz, theta: 4-8 Hz, alpha: 8-13 Hz, beta: 13-30 Hz, gamma: 30-100 Hz). GSR signals are acquired using electrodes placed on fingers or palms and processed using low-pass filtering to extract tonic (skin conductance level) and phasic (skin conductance response) components. Temperature signals are acquired using thermistors or infrared sensors and filtered for noise reduction. All sensor data streams are temporally synchronized and sampled at rates sufficient for real-time processing (e.g., 200 Hz or greater for ECG/EEG, 10-50 Hz for GSR and temperature).

In some implementations, the adaptive controller operates in real time with a control loop latency of less than 500 milliseconds from sensor acquisition to actuator adjustment. The AI module processes incoming biofeedback data using a sliding window approach, where each window captures a temporal segment of sensor data sufficient to characterize the user's current physiological state. The controller continuously evaluates whether current biofeedback signals are within the target resonance profile ranges and generates control commands to adjust steam, light, and sound parameters accordingly.

In some implementations, the continuous calibration mechanism operates as follows: during initial sessions, the controller establishes a baseline physiological profile for the user; during subsequent sessions, the controller refines its learned model based on accumulated user-specific data, progressively improving the accuracy of its therapeutic adjustments. This multi-session learning may employ transfer learning techniques to accelerate adaptation for new users by leveraging patterns learned from prior users with similar physiological characteristics.

In some implementations, the adaptive controller is implemented using commercially available embedded computing hardware (e.g., ARM-based processors, GPU-accelerated edge computing modules), standard biofeedback sensor hardware (e.g., medical-grade ECG/EEG amplifiers, GSR electrodes, digital thermometers), and open-source or commercially available machine-learning frameworks (e.g., TensorFlow, PyTorch).

In some implementations, the adaptive controller implements a closed-loop control architecture comprising three principal modules: (1) a signal acquisition and processing module, (2) a decoding and correlation module, and (3) a feedback and actuation module. The signal acquisition module captures biofeedback signals from the one or more sensors (ECG, EEG, GSR, temperature), which are then preprocessed through filtering, noise reduction, and feature extraction to improve signal quality and detectability. The extracted features include heart rate variability (HRV) metrics derived from ECG data, frequency band powers (delta, theta, alpha, beta, gamma) derived from EEG data, tonic and phasic components derived from GSR data, and temperature trends derived from thermistor data. The decoding module interprets these extracted features using machine-learning algorithms to map the biofeedback signals received from one or more sensors against pre-stored resonance profiles, thereby providing personalized therapeutic treatment.

The feedback module adjusts the therapeutic environment parameters (steam temperature, humidity, light wavelength, light intensity, sound frequency, and sound amplitude) in real time based on the decoded signals from the decoding module. Specifically, the decoded signals comprise the extracted features (HRV metrics, EEG frequency band powers, GSR tonic and phasic components, and temperature trends) that have been correlated against the pre-stored resonance profiles by the decoding module. Based on this correlation, the feedback module determines the appropriate adjustments to the therapeutic environment parameters and outputs control signals to the steam source, multispectral light array, and sound generator. This bidirectional flow of information, from sensor acquisition, to feature extraction, to decoding and correlation, to feedback and actuation, and back to sensor acquisition, enables the system to dynamically adapt its therapeutic output based on changes in the user's physiological state.

In some implementations, the machine-learning algorithms employed by the adaptive controller include one or more of the following: supervised learning classifiers such as support vector machines (SVMs) for classifying physiological states from sensor data; convolutional neural networks (CNNs) for feature extraction from multi-dimensional biofeedback signals; recurrent neural networks (RNNs) or long short-term memory (LSTM) networks for temporal sequence modeling of biofeedback data over time; reinforcement learning (RL) agents that optimize treatment parameters through iterative interaction with the user's physiological responses; and transfer learning techniques that enable the system to adapt pre-trained models to individual users with reduced calibration time.

In some implementations, the adaptive controller employs a reinforcement learning framework in which the controller functions as an agent that observes the user's physiological state (biofeedback signals) as input, takes actions (adjusting steam, light, and sound parameters), and receives rewards based on whether the user's biometric indicators move toward target resonance profiles. The RL agent learns an optimal policy that maps observed biofeedback states to therapeutic parameter adjustments through iterative training. The reward function may incorporate multiple objectives including physiological coherence optimization, user comfort, and therapeutic outcome metrics.

In some implementations, the adaptive controller employs a deep deterministic policy gradient (DDPG) or proximal policy optimization (PPO) algorithm for continuous control of the therapeutic parameters. An actor network determines optimal parameter adjustments given the current biofeedback state, while a critic network evaluates the quality of those adjustments. The neural network architecture may include separate processing pathways for each sensor modality (ECG, EEG, GSR, temperature), with an attention-based fusion mechanism that dynamically weights the contribution of each modality based on signal quality and relevance to the current therapeutic objective.

In some implementations, the stored resonance profiles comprise data structures representing target physiological states associated with specific therapeutic outcomes. Each resonance profile may include target ranges for one or more of: HRV derived from ECG data, EEG frequency band power ratios (e.g., alpha/theta ratio for relaxation, beta power for alertness), galvanic skin response levels indicating autonomic nervous system activation, and body temperature patterns. The adaptive controller correlates real-time biofeedback signals against these stored profiles by computing similarity metrics (e.g., Euclidean distance, cosine similarity, or learned embeddings) between current sensor readings and the target profile values. When the correlation indicates deviation from a target profile, the controller adjusts environmental parameters to guide the user's physiological state back toward the target resonance.

In some implementations, resonance profiles may be pre-configured based on clinical evidence for specific therapeutic outcomes (e.g., a relaxation profile with target alpha wave dominance, reduced GSR, and lowered heart rate), or may be learned and refined over multiple sessions based on individual user responses. The multi-session learning capability enables the system to build personalized resonance profiles that account for individual physiological baselines and response patterns.

The disclosed adaptive bio-resonant healing chamber system provides specific technical improvements over conventional therapeutic systems that lack intelligent, real-time coordination of multisensory modalities. Prior therapeutic environments, including conventional steam rooms, light therapy devices, and sound therapy systems, operate each modality in isolation or, at best, according to fixed, pre-programmed schedules that do not account for a user's real-time physiological state. As a result, conventional systems cannot dynamically tailor the therapeutic environment to the user's changing condition during a session, leading to suboptimal therapeutic outcomes including under-treatment, over-treatment, and inefficient use of therapeutic resources.

The present system overcomes these technical deficiencies through a specific closed-loop control architecture that integrates biofeedback sensing, machine-learning-based signal processing, and coordinated multi-actuator control into a unified therapeutic platform. Unlike conventional systems in which a human operator would need to manually monitor a patient's vital signs and separately adjust steam, light, and sound parameters-a process that is impractical in real time due to the volume and complexity of the data involved—the disclosed adaptive controller processes multiple simultaneous biofeedback data streams (ECG, EEG, GSR, and temperature) at a control loop latency of less than 500 milliseconds and generates coordinated adjustments to all environmental parameters simultaneously. This real-time, multi-input, multi-output control cannot practically be performed by a human operator, and represents a technological solution rooted in the specific hardware and software architecture disclosed herein.

The machine-learning algorithms employed by the adaptive controller are specifically trained to map high-dimensional biofeedback signal features (including HRV metrics, EEG frequency band powers, GSR tonic and phasic components, and temperature trends) against stored resonance profiles representing target physiological states. This correlation is performed using computational techniques including feature extraction through convolutional neural networks, temporal sequence modeling through recurrent neural networks and LSTM networks, and policy optimization through reinforcement learning agents-none of which can practically be performed in the human mind. The output of these algorithms directly controls physical actuators (the steam source, multispectral light array, and sound generator) to effect measurable changes in the user's therapeutic environment, constituting a specific, practical application of the computational methods to the technological field of therapeutic device control.

A further technical improvement provided by the disclosed system is the continuous calibration capability, whereby the adaptive controller updates its internal machine-learning models based on newly acquired biofeedback data both during and between therapeutic sessions, without requiring manual reconfiguration. This iterative learning process enables the system to build personalized resonance profiles that improve therapeutic accuracy over time-a result that is achieved through the specific architecture of the adaptive controller and its integration with the biofeedback sensors and environmental actuators, rather than through any abstract or generalized application of machine-learning.

The combination of a hermetically sealed therapeutic enclosure formed of specific materials (Mylar, hemp, or combinations thereof) that provide both reflective and antimicrobial properties, together with the closed-loop adaptive controller that dynamically coordinates steam, multispectral light, and sound based on real-time biofeedback, constitutes a particular machine that is integral to the claimed methods and imposes meaningful limits on any underlying computational concepts. The system's physical components are not generic hardware to which an abstract idea has been appended; rather, the therapeutic enclosure, the biofeedback sensors, and the environmental actuators each play a significant role in permitting the claimed methods to be performed, and the system as a whole represents an improvement to the technical field of multisensory therapeutic device technology.

### EXAMPLES

In order to illustrate the disclosure, the following examples are included. However, it is to be understood that these examples do not limit the disclosure and are only meant to suggest exemplary methods of practicing the disclosure.

In one example, the disclosed steam tent system was used to treat burns in a 2nd and 3rd-degree burn patient over a 60-day time period. The patient began the described treatment process after an initial waiting period of 5 days. Initially, there was some irritation of the skin of the burn patient, but the tissue responded positively after re-introducing LED light, steam, and A432 sound waves to the affected area in a hermetically sealed non-microbial controlled environment. The burn patient was also able to benefit from the detoxification of pain medication. The burn patient was able to focus on obtaining an overall feeling of well-being and reduced pain significantly with a matter of hours. This process allowed the skin and upper dermal areas to be more malleable for the regeneration process. The steam tent system increased the healing process of the burn patient by 40%.

In another example, a bio-resonant therapeutic apparatus was constructed as follows. A hermetically sealed tent enclosure was formed using a combination of Mylar and hemp fabric, wherein an inner layer of reflective Mylar was laminated to an outer layer of antimicrobial hemp to provide both reflective performance for multispectral light therapy and antimicrobial characteristics. A steam source comprising a pressurized steam generator with a water tank and overflow tank was connected to the enclosure via steam ports to supply the interior with controlled steam at temperatures in a range of from 102 to 120 degrees Fahrenheit. A multispectral light array comprising LED arrays capable of emitting wavelengths in a range of 380 nm to 1100 nm was installed inside the enclosure, including LEDs in the red (660 nm), blue (415 nm), green (525 nm), and near-infrared (850 nm) ranges, affixed to the interior walls using Velcro fasteners. A sound generator comprising speakers configured to produce programmable tones across a frequency range of 1 Hz to 20 kHz was installed, including the nine Solfeggio frequencies at 174 Hz, 285 Hz, 396 Hz, 417 Hz, 528 Hz, 639 Hz, 741 Hz, 852 Hz, and 963 Hz. One or more biofeedback sensors were provided, including a wearable electrocardiogram (ECG) chest strap for detecting cardiac activity, a wearable electroencephalogram (EEG) headband for detecting neural activity, a galvanic skin response (GSR) finger sensor for detecting autonomic nervous system activity, and a digital thermistor for detecting body temperature. The biofeedback sensors were communicatively coupled to an adaptive controller comprising an AI module implemented on an ARM-based embedded computing platform running a machine-learning framework (e.g., TensorFlow). The AI module was programmed with a reinforcement learning algorithm in which the controller functioned as an agent that observed the user's physiological state from the biofeedback sensors as input, took actions by adjusting steam temperature, steam humidity, light wavelength, light intensity, sound frequency, and sound amplitude, and received rewards based on whether the user's biometric indicators moved toward target resonance profiles stored in a database. Each resonance profile defined target values for HRV derived from ECG data, EEG frequency band power ratios (e.g., alpha/theta ratio for relaxation), galvanic skin response levels, and body temperature. The adaptive controller correlated real-time biofeedback signals against these stored profiles by computing similarity metrics between current sensor readings and the target profile values. When deviation was detected, the controller automatically adjusted the steam, light, and sound parameters to guide the user's physiological state back toward the target resonance. During operation, a user was placed inside the hermetically sealed tent enclosure, the biofeedback sensors were applied to the user, and the adaptive controller initiated a therapeutic session. The AI module preprocessed incoming sensor data through bandpass filtering (0.5-100 Hz for ECG, ICA artifact removal for EEG, low-pass filtering for GSR) and processed the data using a sliding window approach with a control loop latency of less than 500 milliseconds. The controller continuously calibrated the therapeutic environment based on accumulated biofeedback data, establishing a baseline physiological profile during the initial session and refining the learned model over subsequent sessions to progressively improve therapeutic accuracy. Therapy session data were securely stored and made accessible to authorized practitioners via encrypted cloud connectivity for longitudinal outcome tracking and clinical assessment.

In another example, a method of providing individualized bio-resonant therapy with predictive healing sequences was practiced as follows. A hermetically sealed tent enclosure formed of a combination of Mylar and hemp was provided, including a steam source, a multispectral light array configured to emit wavelengths in a range of 380 nm to 1100 nm, a sound generator configured to produce frequencies in a range of 1 Hz to 20 kHz including Solfeggio frequencies, and an adaptive controller. A user presenting with symptoms of chronic stress and muscular tension was placed inside the hermetically sealed tent enclosure. Biofeedback sensors including an ECG chest strap, an EEG headband, a GSR finger sensor, and a temperature sensor were applied to the user and communicatively coupled to the adaptive controller. The adaptive controller detected biofeedback signals from the user, including elevated heart rate, elevated GSR indicating autonomic stress response, suppressed EEG alpha wave activity, and a target body temperature within a normal physiological range. The adaptive controller, using machine-learning algorithms implemented as a deep deterministic policy gradient (DDPG) algorithm with separate processing pathways for each sensor modality and an attention-based fusion mechanism, correlated the detected biofeedback signals with stored resonance profiles. The controller identified the user's physiological state as deviating from a stored relaxation resonance profile that defined target values including elevated HRV, dominant alpha wave activity (8-13 Hz), reduced GSR, and a body temperature of 98.4 degrees Fahrenheit. Based on this correlation, the adaptive controller generated a predictive healing sequence comprising a multi-phase cycle of steam, light, and sound optimized for the therapeutic outcome of relaxation. In a first phase of the predictive healing sequence, the controller set the steam source to deliver steam at 108 degrees Fahrenheit at humidity approximately 100, activated the multispectral light array to emit light at 660 nm (red) at a low intensity of approximately 2 J/cm², and set the sound generator to produce a Solfeggio tone at 396 Hz combined with A432 binary beats at 40 beats per minute. The controller monitored the user's biofeedback in real time and, upon detecting a reduction in heart rate and an increase in EEG alpha power after approximately 8 minutes, transitioned to a second phase. In the second phase, the controller adjusted the steam temperature to 105 degrees Fahrenheit, shifted the light array to emit at 525 nm (green) at an intensity of approximately 1.5 J/cm², and changed the sound generator to produce a Solfeggio tone at 528 Hz combined with A432 binary beats at 60 beats per minute. The controller continued to monitor biofeedback and, upon detecting further GSR reduction and body temperature elevation toward 98.4 degrees Fahrenheit, transitioned to a third phase. In the third phase, the controller reduced steam output to maintain ambient warmth, set the light array to emit at 850 nm (near-infrared) at low intensity, and set the sound generator to produce a Solfeggio tone at 174 Hz at reduced amplitude. Throughout the predictive healing sequence, the adaptive controller continuously evaluated whether the user's biofeedback signals were moving within the target resonance profile ranges using cosine similarity metrics and generated control commands to adjust parameters accordingly, with a control loop latency of less than 500 milliseconds. The complete predictive healing sequence lasted approximately 25 minutes. Upon completion, the controller stored the session data, including the biofeedback signal time-series data, the parameter adjustments made at each phase, and the final physiological state of the user, via encrypted cloud connectivity for access by authorized practitioners. Over multiple subsequent sessions with the same user, the adaptive controller employed transfer learning techniques to refine the predictive healing sequences based on accumulated user-specific biofeedback data, progressively improving the accuracy and efficacy of the therapeutic protocol by adaptively adjusting baseline parameters as the user's condition changed over time.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally or alternatively solve other problems than those described above. Furthermore, aspects of the disclosure may provide technical improvements to “conventional” systems or processes as described herein. However, the description only includes example technical improvements resulting from implementing aspects of the disclosure and accordingly do not represent all technical improvements provided within the scope of the claims.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference.

The description set forth herein describes example configurations and does not represent all the examples that may be implemented or that are within the scope of the claims. The term “example” used herein means “serving as an exemplary, instance, or illustration,” and not “preferred” or “advantageous over other examples.” The detailed description includes specific details for the purpose of providing an understanding of the described techniques. These techniques, however, may be practiced without these specific details.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A bio-resonant therapeutic apparatus comprising:
a hermetically sealed tent enclosure;
a steam source configured to supply an interior of the hermetically sealed tent enclosure with steam;
a light source configured to illuminate the hermetically sealed tent enclosure with light, wherein the steam and the light are configured in a predetermined combination to treat a condition of a user;
a sound generator configured to produce frequencies in a range of 1 Hz to 20 kHz;
one or more biofeedback sensors configured to detect biofeedback signals comprising biometric responses of the user; and
an adaptive controller comprising an AI module.

2. The apparatus of claim 1, wherein the adaptive controller automatically adjusts at least one of steam temperature, steam humidity, light wavelength, light intensity, sound frequency, and sound amplitude based on real-time user biofeedback or coordinated biofeedback signals from multiple users.

3. The apparatus of claim 1, wherein the one or more biofeedback sensors include at least one of an electrocardiogram sensor, an electroencephalogram sensor, a galvanic skin response sensor, and a temperature sensor.

4. The apparatus of claim 1, wherein the one or more biofeedback sensors comprise wearable sensors worn by the user, sensors embedded within the hermetically sealed tent enclosure, or external sensors positioned within the hermetically sealed tent enclosure, and wherein data from the one or more biofeedback sensors is transmitted to the adaptive controller for real-time analysis and treatment adjustment.

5. The apparatus of claim 1, wherein the AI module continuously calibrates a therapeutic environment based on the biofeedback signals.

6. The apparatus of claim 1, wherein the adaptive controller generates predictive healing sequences by combining steam, light, and sound cycles optimized for specific therapeutic outcomes.

7. The apparatus of claim 1, wherein the adaptive controller learns from accumulated associated with the biofeedback signals to evolve treatment protocols and adaptively adjust baseline parameters as the user's condition changes over time.

8. The apparatus of claim 1, wherein the adaptive controller securely stores therapy data generated during user sessions and makes the therapy data accessible to authorized practitioners via encrypted cloud connectivity.

9. The apparatus of claim 1, wherein the light source comprises a multispectral light array including LED arrays capable of emitting light in red, blue, green, violet, cyan, yellow, orange, and infrared ranges, and wherein the adaptive controller dynamically selects and adjusts light wavelengths and light intensity based on the user's condition and real-time biofeedback signals.

10. The apparatus of claim 1, wherein the hermetically sealed tent enclosure comprises a combination of Mylar and hemp.

11. The apparatus of claim 1, wherein the hermetically sealed tent enclosure is formed of Mylar.

12. The apparatus of claim 1, wherein the hermetically sealed tent enclosure is formed of hemp fabric comprising bast fibers having a porous surface structure and a hollow core lumen that promotes moisture transport, wherein the hemp fabric exhibits natural antimicrobial and antifungal properties attributable to lignin and pectin content, and wherein the hemp fabric resists growth of mold, mildew, and pathogenic bacteria in the warm, humid environment created by the steam source without requiring chemical antimicrobial treatments.

13. The apparatus of claim 12, wherein the hemp fabric provides moisture-wicking performance enabling the hermetically sealed tent enclosure to absorb and release moisture generated by the steam source, preventing condensation buildup on interior enclosure walls and maintaining a controlled humidity level within a therapeutic environment.

14. The apparatus of claim 12, wherein the hemp fabric is processed using at least one of liquid ammonium treatment to convert a crystal structure of hemp fiber from cellulose I into a mixture of cellulose III and cellulose I to improve moisture management properties, or enzymatic retting to enhance fiber purity and capillary integrity.

15. The apparatus of claim 1, wherein the adaptive controller includes safety protocols comprising automatic shutoff triggers activated upon detection of abnormal biofeedback signals including excessive heart rate, dangerously elevated body temperature, or user distress signals.

16. The apparatus of claim 15, wherein the adaptive controller enforces maximum steam temperature and steam humidity thresholds to prevent unsafe conditions within the hermetically sealed tent enclosure, and wherein an emergency override mechanism is provided to allow the user to manually terminate a session and exit the enclosure at any time.

17. The apparatus of claim 1, further comprising a user interface comprising a mobile or tablet-based application for session configuration, real-time monitoring, and session history review, the application communicating with the adaptive controller via wireless connectivity.

18. The apparatus of claim 17, further comprising a practitioner dashboard for remote monitoring and clinical oversight of one or more bio-resonant therapeutic apparatuses.

19. The apparatus of claim 1, wherein the sound generator produces programmable tones comprising one or more Solfeggio frequencies, and wherein each of the one or more Solfeggio frequency is associated with a specific therapeutic benefit and is selected by the adaptive controller based on the user's condition and biofeedback signals.

20. A method of providing individualized bio-resonant therapy, comprising:
providing a hermetically sealed tent enclosure formed of Mylar or hemp, or a combination thereof, the tent enclosure including a steam source, a multispectral light array configured to emit wavelengths in a range of 380 nm to 1100 nm, and a sound generator configured to produce frequencies in a range of 1 Hz to 20 kHz including Solfeggio frequencies;
placing a user inside the hermetically sealed tent enclosure;
detecting biofeedback signals from the user via one or more biofeedback sensors;
correlating, by an adaptive controller using machine-learning algorithms, the biofeedback signals with stored resonance profiles; and
delivering, by the adaptive controller, individualized therapy by automatically adjusting at least one of steam temperature, steam humidity, light intensity, light wavelength, sound frequency, and sound amplitude based on the correlated biofeedback signals.
